(19) United States
(12) Patent Application Publication
(10) Pub. No.: US 2023/0036539 A1
(43) Pub. Date: Feb. 2, 2023

(54) Waste Liquid Treatment System and Method

(71) Applicant: Max Fann, Arden, NC (US)

(72) Inventor: Max Fann, Arden, NC (US)

(21) Appl. No.: 17/876,510

(22) Filed: Jul. 28, 2022

Related U.S. Application Data
(60) Provisional application No. 63/226,484, filed on Jul. 28, 2021.

(51) Int. Cl. C02F 1/66; C02F 1/00

(52) U.S. Cl. CPC C02F 1/66; C02F 1/008; C02F 2209/06; C02F 2209/003; C02F 2209/02; C02F 2209/40; C02F 2301/04

(57) ABSTRACT

A wastewater treatment system includes a reservoir, a parameter-adjusting subsystem, and a release mechanism. The reservoir is configured to receive waste liquid from a production system and to hold liquid under treatment including the waste liquid. The parameter-adjusting subsystem is configured to measure a parameter of the liquid under treatment and to treat the liquid under treatment to adjust the parameter. The release mechanism is configured to release the liquid under treatment from the reservoir under control of the parameter-adjusting subsystem. A process of treating waste liquid includes receiving waste liquid from a production system into a reservoir, holding liquid under treatment including the received waste liquid in the reservoir, measuring a parameter of the liquid under treatment, treating the liquid under treatment to adjust the measured parameter, and releasing the liquid under treatment from the reservoir after treating the liquid under treatment.

### CROSS-REFERENCE TO RELATED APPLICATION

This is related to, and claims priority from, co-pending U.S. Provisional Application for Patent No. 63/226,484, which was filed on Jul. 28, 2021, the entire disclosure of which is incorporated herein.

### FIELD OF THE INVENTION

The invention is directed to managing and treating waste liquid and other effluent. In particular, the invention is directed to treating process effluent prior to discharge into a municipality collection system.

### BACKGROUND OF THE INVENTION

Many manufacturing and industrial processes produce waste products that must be disposed of, and these waste products can include waste liquid and other effluent. Municipalities collect effluent for central treatment before releasing the treated water back into natural waterways and/or the public water supply system, but typically have certain requirements as to characteristics of the effluent that must fall within prescribed ranges before the effluent will be accepted, to avoid contamination and to lessen the processing burden placed on the municipality. For example, a municipality will often specify a pH range for the effluent, outside of which it will not be accepted. Similarly, a temperature range of acceptable effluent could be specified, or an upper limit on particulate matter or certain chemicals or other components.

As an example, beer brewing and alcoholic beverage distilling produces effluent that must be disposed of. It would be economically beneficial to be able to discharge the effluent to a municipality's public treatment system, but the brewer/distiller must first comply with local regulations as to characteristics of the effluent. Typically, acceptable pH and temperature ranges are specified, as well as a maximum flow rate or total volume of discharge over time. Non-compliance can result in fines or even disconnection from the municipal system, both of which would be economically burdensome. However, it can also be difficult, time-consuming, and expensive to comply with local regulations. Therefore, a system and method for treating the effluent that is easy to implement is needed.

### BRIEF SUMMARY OF THE INVENTION

According to an aspect of the invention, a wastewater treatment system includes a reservoir, a parameter-adjusting subsystem, and a release mechanism. The reservoir is configured to receive waste liquid from a production system and to hold liquid under treatment including the waste liquid. The parameter-adjusting subsystem is configured to measure a parameter of the liquid under treatment and to treat the liquid under treatment to adjust the parameter. The release mechanism is configured to release at least a portion of the liquid under treatment from the reservoir under control of the parameter-adjusting subsystem.

For example, the parameter-adjusting subsystem can be a pH-adjusting subsystem configured to determine a pH of the liquid under treatment and to treat the liquid under treatment to adjust the pH. The release mechanism can be configured to release at least a portion of the liquid under treatment from the reservoir under control of the pH-adjusting subsystem.

As another example, the parameter-adjusting subsystem can be a temperature-adjusting subsystem configured to determine a temperature of the liquid under treatment and to treat the liquid under treatment to adjust the temperature. The release mechanism can be configured to release at least a portion of the liquid under treatment from the reservoir under control of the temperature-adjusting subsystem.

The wastewater treatment system can be scaled to include multiple parameter-adjusting subsystems. The parameter-adjusting subsystems can be configured to measure a respective multiple parameters of the liquid under treatment and to treat the liquid under treatment to adjust the respective multiple parameters. The release mechanism can be configured to release at least a portion of the liquid under treatment from the reservoir under control of the multiple parameter-adjusting subsystems.

An exemplary production system is a beverage production system, in which case the waste liquid is produced during a beverage production process.

The release mechanism can be configured to release the liquid under treatment from the reservoir at a controlled flow rate, such as a preselected flow rate or a selectable flow rate.

The system can also include a circulation system configured to circulate the liquid under treatment held in the reservoir.

According to another aspect of the invention, a process of treating waste liquid includes receiving waste liquid from a production system into a reservoir, holding liquid under treatment including the received waste liquid in the reservoir, measuring a parameter of the liquid under treatment, treating the liquid under treatment to adjust the measured parameter, and releasing at least a portion of the liquid under treatment from the reservoir after treating the liquid under treatment.

The parameter can be, for example, a pH of the liquid under treatment, or a temperature of the liquid under treatment.

The process can include measuring multiple parameters of the liquid under treatment and adjusting the multiple parameters of the liquid under treatment.

The production system can be, for example, a beverage production system, in which case the waste liquid can be produced during a beverage production process.

The liquid under treatment can be released at a controlled flow rate, such as at a preselected flow rate or a selectable flow rate.

The process can also include circulating the liquid under treatment held in the reservoir.

### BRIEF DESCRIPTION OF THE DRAWINGS

FIG. 1 is a schematic diagram of an exemplary embodiment of the system of the invention.

FIG. 2 is a schematic diagram of an exemplary embodiment of the system of the invention, scaled to process multiple parameters.

FIG. 3 is a schematic diagram of an exemplary embodiment of the system of the invention, including a circulation subsystem.

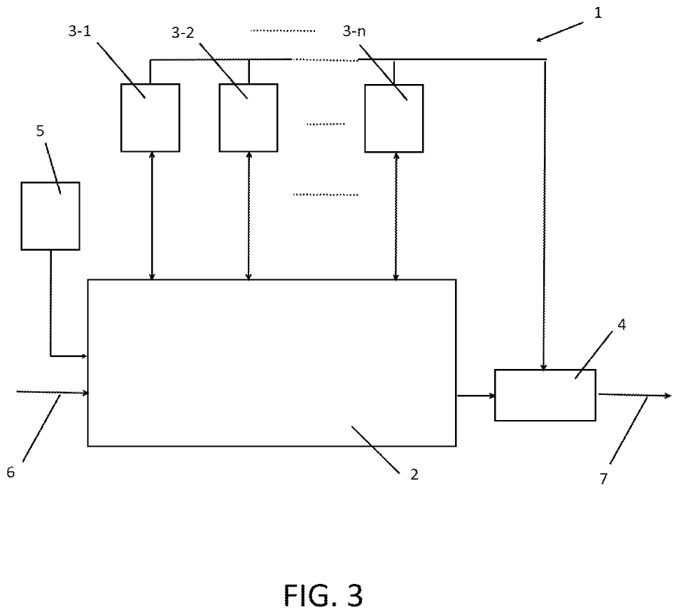

FIG. 4 is a flow diagram of an exemplary embodiment of the process of the invention.

### DETAILED DESCRIPTION OF THE INVENTION

The invention is a system and a method by which industrial effluent or waste liquid of a production system is treated. Specifically, the system and method treat effluent with regard to certain parameters and characteristics, such as pH and temperature, and control discharge liquid with respect to flow rate or total volume over time. The treated liquid can then be released, for example, into a municipal public wastewater system for further processing. Many characteristics of the effluent can be determined and treated if necessary. The characteristics of pH and temperature, and the flow rate of the treated liquid, are discussed herein by way of example and not limitation. Also used as an example herein for convenience only will be the application of effluent resulting from the beer brewing process, or, similarly, from the alcohol distilling process. Breweries and distillers produce effluent as a waste product of the brewing and distilling process. The effluent must be disposed of, and the most efficient and economical way to dispose of the waste liquid is to release the effluent into the local municipal wastewater system. As discussed above, the effluent must first be treated according to local standards.

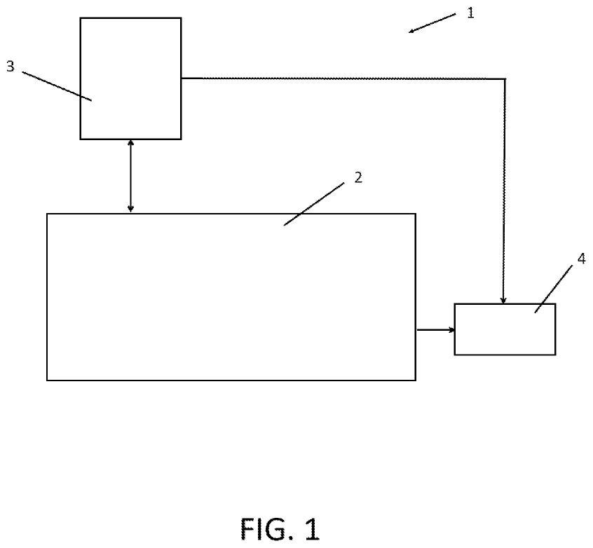

With reference to FIG. 1, because the effluent must be treated before discharge, the system 1 of the invention includes a reservoir 2 configured to receive the effluent 6 and to be used as a temporary holding space for the effluent 6 for testing and treatment. The liquid held in the reservoir 2 at any time will be referred to herein as the liquid under treatment. This liquid includes a mix of waste liquid that has just been received into the reservoir 2 and liquid that has been held in the reservoir 2 while awaiting testing, treatment, or release. Flow of effluent 6 into the reservoir 2 must be timed so as not to interfere with testing or release of liquid already in the reservoir 2. So as not to delay transfer of effluent 6 to the reservoir 2, the reservoir 2 can include an initial holding tank, configured to receive the effluent 6 and hold the effluent 6 until the main reservoir 2 is ready to accept the effluent 6 into the liquid under treatment. Regardless of whether a particular system includes an initial holding tank, new effluent 6 should not be accepted by the reservoir 2 if the liquid under treatment currently held in the reservoir 2 is undergoing parameter testing, is undergoing treatment, or is being released into the municipal wastewater system, and therefore without an initial holding tank timing must be controlled manually or automatically.

The rate of release of treated liquid 7 into the municipal system might also have to be controlled, according to local regulations. A metered valve, such as a controlled solenoid valve, or drainage flap at the outlet of the reservoir 2 can be provided to control the rate of output flow. This mechanism can be set to constrain output flow to a predetermined level, can be automatically timed to conform to any variation in allowable rates at different times or day, or can be set or selectable by a user.

When new effluent 6 is added to the reservoir 2, it will mix with the liquid under treatment already held in the reservoir 2. If allowed to mix naturally, the combined contents of the reservoir 2 could eventually become somewhat homogeneous. However, in order to conform to a treatment schedule, the mix should be made substantially homogeneous more quickly. Therefore, the system 1 of the invention can include a circulation subsystem 5 configured to circulate the liquid under treatment held in the reservoir 2. The circulation subsystem 5 can be used to circulate the contents of the reservoir 2 to make it more homogeneous so that any testing of the contents will be more accurate. The circulation subsystem 5 can be configured to be actuated in response to action by a user. Alternatively, or in addition, the circulation subsystem 5 can be configured to be actuated automatically, for example, within a predetermined time after new effluent 6 is added to the reservoir 2 or according to a regular timed schedule. Actuation of the circulation subsystem 5 can be timed to last for a predetermined amount of time, or for an amount of time that depends on the volume or weight of liquid content in the reservoir 2. In some cases, the nature of the liquid under test could be such that periodic mixing is beneficial, such as when the contents include particulate matter that can settle over time, or components that tend to separate when not physically agitated. In this case, automatic actuation can take place according to a timed schedule, which can be fixed or which can depend on the volume or weight of the contents of the reservoir 2. Actuation of the circulation subsystem 5 can also take place during a predetermined time before testing, either manually or automatically. The circulation subsystem 5 can be configured in any way to maximize the accuracy of parameter testing by making the contents of the reservoir 2 more homogenous.

As discussed, the liquid under treatment will be tested and treated with respect to certain parameters or characteristics, by a parameter-adjusting subsystem 3. For example, the effluent 6 can be tested and treated to meet the local specification for pH. Typically, a municipality will require the pH of effluent to be discharged into the municipal system to fall within a prescribed range. To accomplish this, the system 1 of the invention can include a pH-adjusting subsystem. The pH-adjusting subsystem is configured to determine a pH of the liquid under treatment and to treat the liquid under treatment to adjust the pH until it falls within the required range. Effluent 6 is received by the reservoir 2, either directly from the source or from an initial holding tank. Preferably, all the liquid held in the reservoir 2 is mixed by a circulation subsystem 5. At an appropriate time, the liquid is tested to determine its pH. If the determined pH falls within the predetermined acceptable range, the liquid under treatment is ready for release into the municipal wastewater treatment system. If the determined pH does not fall within the predetermined acceptable range, the liquid under treatment is treated to adjust the pH until the determined pH falls within the predetermined acceptable range, at which point the liquid under treatment is ready for release into the municipal wastewater treatment system. Preferably, the system 1 of the invention includes a release mechanism 4 that allows release of at least some of the liquid into the municipal system only after an acceptable test result, and only at a controlled flow rate allowed by the municipal system. The flow rate can be set to a predetermined value, or can be selected by an operator of the system 1. To facilitate this release while allowing for continuous receiving and treatment of effluent 6, a release tank separate from the reservoir 2 can be provided to hold acceptable liquid awaiting release, leaving the reservoir 2 free to receive more effluent 6.

Similarly, the system 1 of the invention can include a temperature-adjusting subsystem that is configured to determine and control a temperature of the liquid under treatment. Certain municipal wastewater treatment systems require liquid released into the system to have a temperature within a certain range. The temperature-adjusting subsystem of the invention makes sure that the temperature of any liquid released into the municipal system falls within the acceptable range, by testing the temperature of the liquid under treatment and then adjusting the temperature if necessary. The release mechanism 4 can also be configured to release the liquid under treatment from the reservoir 2 under further control of the temperature-adjusting subsystem.

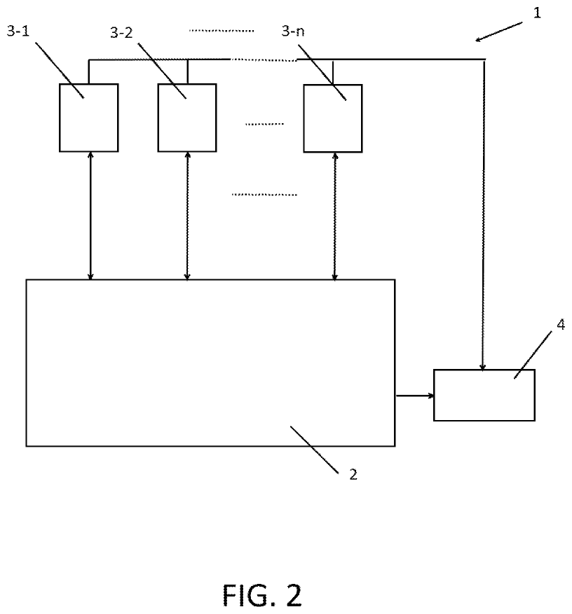

A single system 1 could test and treat liquid waste for one or these exemplary parameters, or for multiple parameters using the same system. Referring to FIG. 2, the system 2 is scalable to allow for multiple parameter-adjusting subsystems 3-1, 3-2, . . ., 3-n, each of which can be used to test for and treat different parameters of the waste liquid.

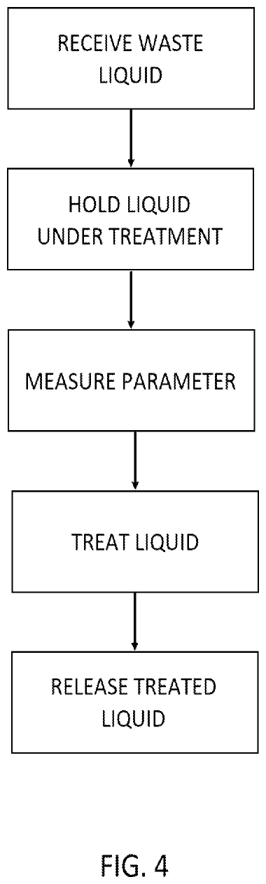

With reference to FIG. 4, independent of the structural system 1 of the invention, the invention also includes a process of treating waste liquid that includes receiving waste liquid from a production system into a reservoir 2, which might include an initial holding tank and/or a release tank. Liquid under treatment including the received waste liquid is held in the reservoir 2 and one or more parameters of the liquid under treatment are measured and treated if necessary to adjust the measured parameter. After treating the liquid under treatment as necessary, at least a portion of the liquid under treatment is released from the reservoir 2, such as into a municipal wastewater system.

As noted above, the tested and treated parameter can be, for example, a pH of the liquid under treatment, and/or a temperature of the liquid under treatment, and/or any other single or multiple parameters of the liquid under treatment, preferably with circulation of the liquid under treatment taking place at suitable times during the overall process. The particular tested and treated parameters will depend on the production system providing the waste liquid. The process of the invention can be applied to any type of industrial or production system that produces waste liquid such as, for example, a beverage production system, in which case the waste liquid can be produced during a beverage production process. In any case, the liquid under treatment can be released at a controlled flow rate, such as at a preselected flow rate or a selectable flow rate.

The production system waste liquid can be delivered to the reservoir 2 by any conduit or channel appropriate to the setting and the viscosity of the liquid, such as by a gravity-feed pipe or series of pipes, or a pressure-driven system by which waste liquid is drawn to a pump and fed under pressure to the reservoir 2. In the case of a mobile set-up such as a shipping container facility, waste liquid can collect in a trench drain in the flooring, and can be gravity-fed to the reservoir 2 or pumped to the reservoir 2, such as through the use of an epoxy pump or other appropriate pump mechanism.

Because the waste liquid can include elements as diverse as chemicals (which can be caustic and acid), food waste, alcohol, water, and the like, the particular channel network and pumping/filtering system should be provided to most efficiently deal with that liquid composition, given any structural and space limitations imposed by the environment in which it is set up. Because the waste liquid can include suspended debris, the collection system might require a filtration subsystem and the process might require one or more filtering actions prior to collection in the treatment reservoir 2. Preferably a trap for collected solid waste taken from the liquid waste is provided to allow for proper collection and disposal. The reservoir 2 is constructed of a material appropriate to the liquid being treated in the particular application, such as from some type or metal or plastic. For example, a strong plastic material designed to withstand concentrated chemicals could be used to construct the reservoir 2 and any conduit or tubing.

Whether a pump is used, what type of pump is used, and the materials used for the reservoir 2 and conduits depends on the application and on the location of the system 1 and components of the system 1. For example, if interior space is tight, the conduit, the pump (if necessary), and even the reservoir 2 can be arranged outside of the building or container, such as attached to an exterior wall, mounted on the roof, or even mounted below the floor if the production facility is, for example, a mobile container such as a shipping container that is raised and supported off the ground. If this is the case, the environment and exposure to the elements must be considered when determining the construction materials to be used. Also depending on the application, any components of the system 1 that are arranged outside of the building, enclosure, or container might include ornamental features that blend with the exterior or provide a decorative or identifying aspect. The particular application will also determine the size of the reservoir 2 and any channels and piping, and the rating of any pumps and valves used as part of the system 1.

An exemplary industrial application is a mobile brewery or distilling system used to brew beer or distill spirits. In such an application, liquid waste can be diverted from the brewing or distilling system's local drainage outlet into a pump, such as a magnetic pump. Preferably the pump is a self-priming device that turns on with liquid contact for incoming waste. The pump's inlet can include a solenoid one-way valve or other mechanism to prevent backflow. The waste liquid is then directed from the pump into the reservoir 2, which in this case can be, for example, a polyethylene storage container. Testing and treatment take place in this reservoir 2, as described above, and the reservoir 2 can be further divided for temporary holding of liquid as required. The pump used to provide the waste liquid to the reservoir 2 can also be used to recirculate the liquid under treatment, which can be performed automatically according to a schedule, such as every four hours, or manually, in order to homogenize the liquid under treatment. That is, the pump can have two inlet valves; one valve allows accepts incoming waste liquid to be pumped into the reservoir 2, and the other valve initiates a recirculation pathway when recirculation action is actuated. Another valve can control the return end of the recirculation pathway. These valves are coupled to the reservoir 2 and other components, for example, by way of an NPT connection. For convenience, the pump can be fixed to an outer wall of the reservoir 2, such as by bolting it to the reservoir 2, maintaining a fixed conduit to the interior of the reservoir 2.

As mentioned above, one of the parameters for which the waste liquid can be tested and treated is pH level. In this case, the reservoir 2 can be equipped with a pH sensor that continuously or periodically monitors the pH of the waste liquid, or which tests the pH level when manually directed to do so. If temperature is another parameter to be tested and treated, a separate temperature monitor can be included to continuously or periodically monitors the temperature of the waste liquid, or to test the temperature when manually directed to do so. Alternatively, the pH sensor can include a temperature monitor. In either case, the temperature monitor can include a temperature probe to sample the liquid temperature and report the sensed temperature back to the monitor.

If the detected pH is above a predetermined pH threshold, for example, 5.0, the liquid can be adjusted to reduce the pH, such as by adding a pH-buffering alkaline solution to the liquid under treatment. This alkaline solution can be provided to the reservoir 2 by a dosing pump or other mechanism, preferably through a controllable valve such as a solenoid valve. The alkaline solution is preferably stored in a chemical container, on top of the reservoir 2 or in an otherwise accessible location, with the dosing pump feed submerged inside the chemical container. Control of this valve and other electronic functions of the system 1 can be provided by a programmable logic control (PLC) system, the computer or microprocessor for which is secured in a location protected from environmental factors, such watertight bolted on the top of the reservoir 2. The pH gauge used to measure the pH of the liquid under treatment can be connected to the PLC system, which can then control the taking of scheduled readings and the operation of the waste release valve.

If the detected temperature is above a threshold temperature, for example, 104° F., the liquid can be adjusted to reduce the temperature, such as by adding unheated tap water or gray water to the liquid under treatment, preferably by way of a controllable valve, such as a solenoid valve. This cooling water can be provided to the reservoir 2 through a through a valve, such as a solenoid valve controlled by the PLC system. The temperature gauge used to measure the temperature of the liquid under treatment can be connected to the PLC system, which can then control the taking of scheduled readings and the operation of the waste release valve.

While or after treatment for pH and/or temperature and/or any other parameter is taking place, the circulation subsystem can mix the liquid under treatment to homogenize the liquid for follow-up testing. Once the tested pH and/or temperature and/or other tested parameter(s) are determined to be within desired ranges, the liquid in the reservoir 2 is ready to be released into the municipal wastewater system, at a prescribed flow rate controlled by the PLC system.

Thus, the waste liquid treatment process of the invention provides three main functions, namely, waste collection, waste testing and treatment (preferably including recirculation), and treated waste removal. Various elements of the system 1 of the invention provide these functions. The system 1 of the invention provides exemplary structure to provide the process. Waste collection can be made from any of various industrial applications, and testing and treatment can be directed to any parameters of the waste liquid as required by the particular application and by municipal requirements. The system 1 is scalable in size and capability for use with large production plants in stationary buildings and with smaller, mobile set-ups. In the case of mobile applications, the PLC system can be programmed to adjust treatments and release functions to suit the requirements of the municipality in which it is used at any particular time. The system 1 can also be implemented as a modular, plug-and-play unit, with the optional pump and subsystems coupled to the reservoir 2, having ports configured to couple with an effluent pipe or conduit and with an input to the municipal wastewater system. The system 1 can then be transported to the environment in which it will be used, secured at the location, and coupled to the effluent output and municipal wastewater input. Likewise, the reservoir can be constructed with multiple inputs for parameter testing and treatment subsystems, which are coupled to appropriate subsystems as needed, and capped off if not in use.

The invention has been described by way of example and in terms of preferred embodiments. However, the invention as contemplated by the inventor is not strictly limited to the particularly disclosed embodiments. To the contrary, various modifications, as well as similar arrangements, are included within the spirit and scope of the invention. The scope of the appended claims, therefore, should be accorded the broadest reasonable interpretation so as to encompass all such modifications and similar arrangements.

I claim:

1. A wastewater treatment system, comprising;
a reservoir;
a parameter-adjusting subsystem; and
a release mechanism;
wherein the reservoir is configured to receive waste liquid from a production system and to hold liquid under treatment including the waste liquid;
wherein the parameter-adjusting subsystem is configured to measure a parameter of the liquid under treatment and to treat the liquid under treatment to adjust the parameter; and
wherein the release mechanism is configured to release at least a portion of the liquid under treatment from the reservoir under control of the parameter-adjusting subsystem.

2. The wastewater treatment system of claim 1, wherein the parameter-adjusting subsystem is a pH-adjusting subsystem configured to determine a pH of the liquid under treatment and to treat the liquid under treatment to adjust the pH; and
wherein the release mechanism is configured to release at least a portion of the liquid under treatment from the reservoir under control of the pH-adjusting subsystem.

3. The wastewater treatment system of claim 1, wherein the parameter-adjusting subsystem is a temperature-adjusting subsystem configured to determine a temperature of the liquid under treatment and to treat the liquid under treatment to adjust the temperature; and
wherein the release mechanism is configured to release at least a portion of the liquid under treatment from the reservoir under control of the temperature-adjusting subsystem.

4. The wastewater treatment system of claim 1, wherein the parameter-adjusting subsystem is a plurality of parameter-adjusting subsystems, wherein the parameter-adjusting subsystems are configured to measure a respective plurality of parameters of the liquid under treatment and to treat the liquid under treatment to adjust the respective plurality of parameters; and
wherein the release mechanism is configured to release at least a portion of the liquid under treatment from the reservoir under control of the plurality of parameter-adjusting subsystems.

5. The system of claim 1, wherein the production system is a beverage production system, and the waste liquid is produced during a beverage production process.

6. The system of claim 1, wherein the release mechanism is configured to release the at least a portion of the liquid under treatment from the reservoir at a controlled flow rate.

7. The system of claim 6, wherein the controlled flow rate is a preselected flow rate.

8. The system of claim 6, wherein the controlled flow rate is a selectable flow rate.

9. The system of claim 1, further comprising a circulation subsystem configured to circulate the liquid under treatment held in the reservoir.

10. A process of treating waste liquid, comprising:
receiving waste liquid from a production system into a reservoir;
holding liquid under treatment including the received waste liquid in the reservoir;
measuring a parameter of the liquid under treatment;
treating the liquid under treatment to adjust the measured parameter; and
releasing at least a portion of the liquid under treatment from the reservoir after treating the liquid under treatment.

11. The process of claim 10, wherein the parameter is a pH of the liquid under treatment.

12. The process of claim 10, wherein the parameter is a temperature of the liquid under treatment.

13. The process of claim 10, wherein:
measuring a parameter of the liquid under treatment includes measuring a plurality of parameters of the liquid under treatment; and
treating the liquid under treatment includes adjusting the plurality of parameters of the liquid under treatment.

14. The process of claim 10, wherein the production system is a beverage production system, and the waste liquid is produced during a beverage production process.

15. The process of claim 10, wherein releasing the at least a portion of the liquid under treatment from the reservoir includes releasing the at least a portion of the liquid under treatment at a controlled flow rate.

16. The process of claim 15, wherein the controlled flow rate is a preselected flow rate.

17. The process of claim 15, wherein the controlled flow rate is a selectable flow rate.

18. The process of claim 10, further comprising circulating the liquid under treatment held in the reservoir.
